(19) United States
(12) Patent Application Publication
(10) Pub. No.: US 2018/0181533 A1
(43) Pub. Date: Jun. 28, 2018

(54) ENDING WRITE DATA TRANSFER IN I3C HDR-DDR MODE

(71) Applicant: QUALCOMM Incorporated, San Diego, CA (US)

(72) Inventor: Radu PITIGOI-ARON, San Jose, CA (US)

(21) Appl. No.: 15/846,082

(22) Filed: Dec. 18, 2017

Related U.S. Application Data
(60) Provisional application No. 62/438,143, filed on Dec. 22, 2016.

(51) Int. Cl. G06F 13/42; G06F 13/26; G06F 13/364; G06F 13/40; H04L 12/40

(52) U.S. Cl. CPC G06F 13/4291; G06F 13/26; H04L 12/4013; G06F 13/4022; G06F 13/4072; G06F 13/364

(57) ABSTRACT

Systems, methods, and apparatus are described that enable communication of flow-control signals over a serial bus. A method performed at a device coupled to the serial bus includes transmitting first data over the serial bus, transmitting one or more preamble bits preceding second data, disabling a driver coupled to a first wire of the serial bus while transmitting the preamble bits and while the first wire is in a first signaling state, terminating data transmission when the first wire has transitioned from the first signaling state to a second signaling state while the preamble bits are being transmitted, and transmitting second data after transmitting the preamble bits when the first wire has remained in the first signaling state during transmission of the preamble bits.

### PRIORITY CLAIM

This application claims priority to and the benefit of provisional patent application No. 62/438,143 filed in the United States Patent Office on Dec. 22, 2016, the entire content of which is incorporated herein by reference as if fully set forth below in its entirety and for all applicable purposes.

### TECHNICAL FIELD

The present disclosure relates generally to an interface between processing circuits and peripheral devices and, more particularly, to providing a flow control capability through signaling on a serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol.

In one example, the Inter-Integrated Circuit serial bus, which may also be referred to as the I2C bus or the I²C bus, is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL).

The Mobile Industry Processor Interface (MIPI) Alliance has defined standards and protocols that may be used to operate a serial bus at higher data rates than permitted when the serial bus is operated in accordance with I2C protocols. In a single data rate (SDR) mode of operation, an I3C protocol inherits certain implementation aspects from I2C protocols. SDR mode may be compatible with I2C protocols used by conventional slave devices coupled to the serial bus. The MIPI Alliance defines high data rate (HDR) modes for use on a serial bus. In one HDR mode, for example, SCL is clocked at 12.5 Mhz. Conventional slave devices that are limited to communicating through I2C protocols can coexist on the serial bus if they ignore HDR transmissions.

In many conventional serial buses, a receiver cannot signal the sender to stop transmission while the sender is actively driving the wires of the serial bus during data transfers. In the context of I2C or I3C protocols, a slave device cannot intervene to stop transmission while a master device is actively driving the wires of the I2C or I3C bus when transferring data. That is, slave devices coupled to a serial data bus have no flow control capabilities when receiving data, and cannot assert flow control signals to cause a transmitter to pause or halt a transmission. In some circumstances, a slave device may drop data and withhold acknowledgement of a transmission when the buffers in a slave device overflow. Failed transmissions due to dropped data can negative affect system latencies. Such issues are exacerbated by increasing demands on bandwidth to support increased data volumes with certain types of device. Accordingly, improvements are continually needed to improve data throughput and reduce latencies associated with serial bus interfaces.

### SUMMARY

Certain aspects of the disclosure relate to systems, apparatus, methods and techniques that provide a flow control mechanism that can be used on a multi-mode serial bus including an I3C bus that is operated in a double data rate (DDR) mode of operation.

In various aspects of the disclosure, a method performed at a transmitting device coupled to a serial bus includes transmitting first data over the serial bus, transmitting one or more preamble bits preceding second data transmitted on the serial bus, disabling a driver coupled to a first wire of the serial bus while transmitting the one or more preamble bits and while the first wire is in a first signaling state, terminating data transmission over the serial bus when the first wire of the serial bus has transitioned from the first signaling state to a second signaling state while the one or more preamble bits are being transmitted, and transmitting second data over the serial bus after transmitting the one or more preamble bits when the first wire of the serial bus has remained in the first signaling state during transmission of the one or more preamble bits.

In one aspect, the transmitting device is a master device, and disabling the driver coupled to the first wire of the serial bus includes causing a line driver coupled to the serial bus to enter a high impedance state, and enabling a pull-up circuit coupled to the first wire of the serial bus.

In one aspect, transmitting the first data over the serial includes transmitting a bit of data on each edge of a pulse of a clock signal transmitted on a second wire of the serial bus.

In one aspect, the serial bus is operated in accordance with an I3C protocol. Terminating data transmission over the serial bus includes transmitting a HDR exit pattern or a HDR restart pattern on the serial bus.

In various aspects of the disclosure, an apparatus has a first line driver coupled to a first wire of a multi-wire serial bus, a second line driver coupled to a second wire of the multi-wire serial bus, and an interface controller configured to transmit first data over the serial bus, transmit one or more preamble bits preceding second data transmitted on the serial bus, disable a driver coupled to a first wire of the serial bus while transmitting the one or more preamble bits and while the first wire is in a first signaling state, terminate data transmission over the serial bus when the first wire of the serial bus has transitioned from the first signaling state to a second signaling state while the one or more preamble bits are being transmitted, and transmit second data over the serial bus after transmitting the one or more preamble bits when the first wire of the serial bus has remained in the first signaling state during transmission of the one or more preamble bits.

In some aspects, the apparatus is a master device, and the apparatus includes a pull-up circuit configured to be coupled to the first wire of the serial bus. The driver coupled to the first wire of the serial bus may be disabled by causing the first line driver to enter a high impedance state, and enabling the pull-up circuit.

In one aspect, the interface controller is configured to transmit a bit of data on each edge of a pulse of a clock signal transmitted on a second wire of the serial bus in the DDR mode of operation.

In some aspects, the serial bus is operated in accordance with an I3C protocol. The interface controller may be configured to transmit an HDR exit pattern or HDR restart pattern on the serial bus when terminating data transmission over the serial bus.

In various aspects of the disclosure, a method performed at a receiving device coupled to a serial bus includes receiving first data from the serial bus, enabling a driver coupled to a first wire of the serial bus while one or more preamble bits are being transmitted over the serial bus after the first data has been received, and driving the first wire of the serial bus from a first signaling state to a second signaling state. Driving the first wire of the serial bus to the second signaling state while the one or more preamble bits are being transmitted may be indicative of a request by the receiving device to have data transmission over the serial bus terminated.

In one aspect, the receiving device is a master device. The driver coupled to the first wire of the serial bus may be enabled by causing a line driver coupled to the serial bus to exit a high impedance state.

In one aspect, receiving the first data over the serial bus includes using each edge of a pulse in a signal transmitted on a second wire of the serial bus to receive a bit of data.

In some aspects, the serial bus may be operated in accordance with an I3C protocol. The receiving device may receive an HDR exit pattern or HDR restart pattern from the serial bus, where HDR exit pattern and the HDR restart pattern are associated with a termination of a current data transmission over the serial bus.

In various aspects of the disclosure, an apparatus includes a first line driver coupled to a first wire of a multi-wire serial bus, a second line driver coupled to a second wire of the multi-wire serial bus, and an interface controller configured to receive first data from the serial bus, enable a driver coupled to a first wire of the serial bus while one or more preamble bits are being transmitted over the serial bus after the first data has been received, and drive the first wire of the serial bus from a first signaling state to a second signaling state. The first wire of the serial bus being driven to the second signaling state while the one or more preamble bits are being transmitted may be indicative of a request by the receiving device to have data transmission over the serial bus terminated.

In one aspect, the apparatus is a master device, and the interface controller causes a line driver coupled to the serial bus to exit a high impedance state.

In one aspect, the interface controller receives the first data over the serial bus using each edge of a pulse in a signal transmitted on a second wire of the serial bus to receive a bit of data.

The serial bus may be operated in accordance with an I3C protocol. The receiving device may receive an HDR exit pattern or HDR restart pattern from the serial bus, where HDR exit pattern and the HDR restart pattern are associated with a termination of a current data transmission over the serial bus.

### BRIEF DESCRIPTION OF THE DRAWINGS

FIG. 1 illustrates an apparatus employing a data link between IC devices that is selectively operated according to one of plurality of available standards.

FIG. 2 illustrates a communication link in which a configuration of devices are connected using a serial bus.

FIG. 3 illustrates certain aspects of an apparatus that includes multiple devices connected to a serial bus.

FIG. 4 includes a timing diagram that illustrates signaling on a serial bus when the serial bus is operated in a single data rate (SDR) mode of operation defined by I3C specifications.

FIG. 5 is a timing diagram 500 that illustrates an example of a transmission in an I3C high data rate (HDR) mode, where data is transmitted at double data rate (DDR).

FIG. 6 illustrates an example of signaling transmitted on the SDA wire and SCL wire of a serial bus to initiate certain mode changes.

FIGS. 7 and 8 provide timing diagrams that illustrate an example of flow-control asserted by a master device during transmission of data from a slave device to the master device in accordance with certain aspects disclosed herein.

FIGS. 9 and 10 provide timing diagrams that illustrate an example of flow-control asserted by a slave device during transmission of data from a master device to the slave device in accordance with certain aspects disclosed herein.

FIG. 11 illustrates an example of line driving circuits that may be used to provide hardware flow control in accordance with certain aspects disclosed herein.

FIG. 12 is a block diagram illustrating an example of an apparatus employing a processing circuit that may be adapted according to certain aspects disclosed herein.

FIG. 13 is a flowchart 1300 illustrating a flow-control process that may be performed at a sending device coupled to a serial bus in accordance with certain aspects disclosed herein.

FIG. 14 illustrates a hardware implementation for a transmitting apparatus adapted to respond to a provide a flow control capability in accordance with certain aspects disclosed herein.

FIG. 15 is a flowchart illustrating a flow-control process that may be performed at a receiving device coupled to a serial bus in accordance with certain aspects disclosed herein.

FIG. 16 illustrates a hardware implementation for a receiving apparatus adapted to respond to a flow control capability in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Apparatus that includes one or more SoCs or other IC devices may include or be coupled to peripherals, sensors, and other components that care communicatively coupled through a serial bus. In one example, a serial bus may be employed to connect an application processor or other host device with modems, sensors and/or other peripherals. The serial bus may be operated in accordance with a standard or protocol such as the I2C, I3C, serial low-power inter-chip media bus (SLIMbus), system management bus (SMB), radio frequency front-end (RFFE) protocols that define timing relationships between signals and transmissions.

Certain aspects disclosed herein relate to systems, apparatus, methods and techniques that provide a flow control mechanism that can be used on an I3C bus that is operated in a DDR mode of operation. For example, a method performed at a transmitting device coupled to a serial bus includes transmitting first data over the serial bus while the serial bus is configured for a DDR mode of operation, transmitting one or more preamble bits preceding second data transmitted on the serial bus, disabling a driver coupled to a first wire of the serial bus while transmitting the one or more preamble bits and while the first wire is in a first signaling state, terminating data transmission over the serial bus when the first wire of the serial bus has transitioned from the first signaling state to a second signaling state while the one or more preamble bits are being transmitted, and transmitting second data over the serial bus after transmitting the one or more preamble bits when the first wire of the serial bus has remained in the first signaling state during transmission of the one or more preamble bits.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

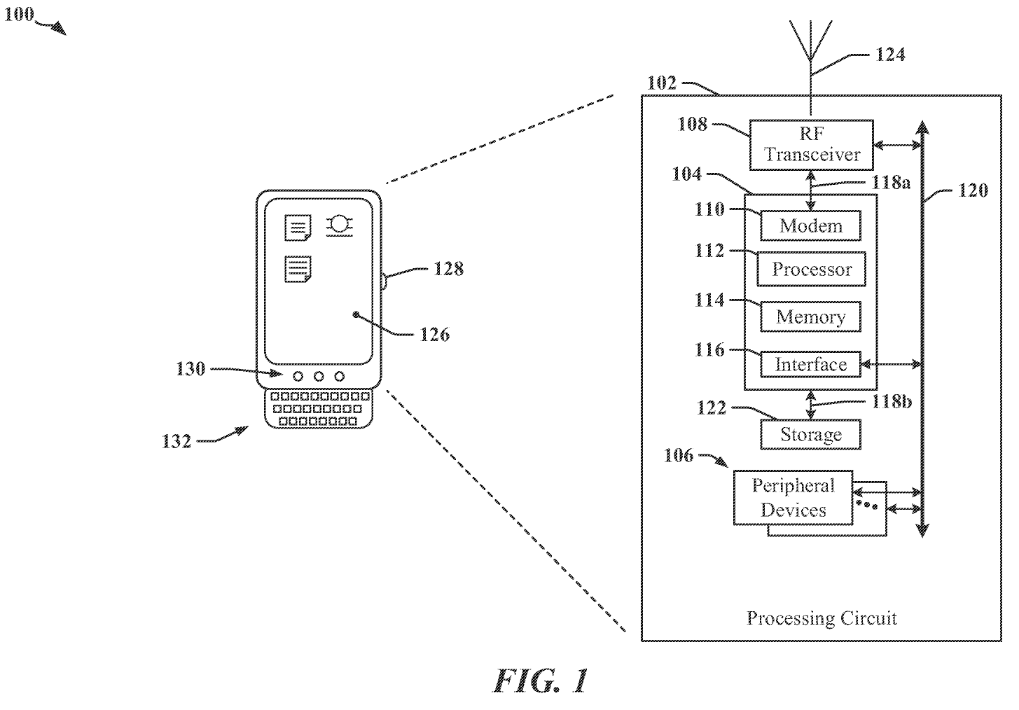

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

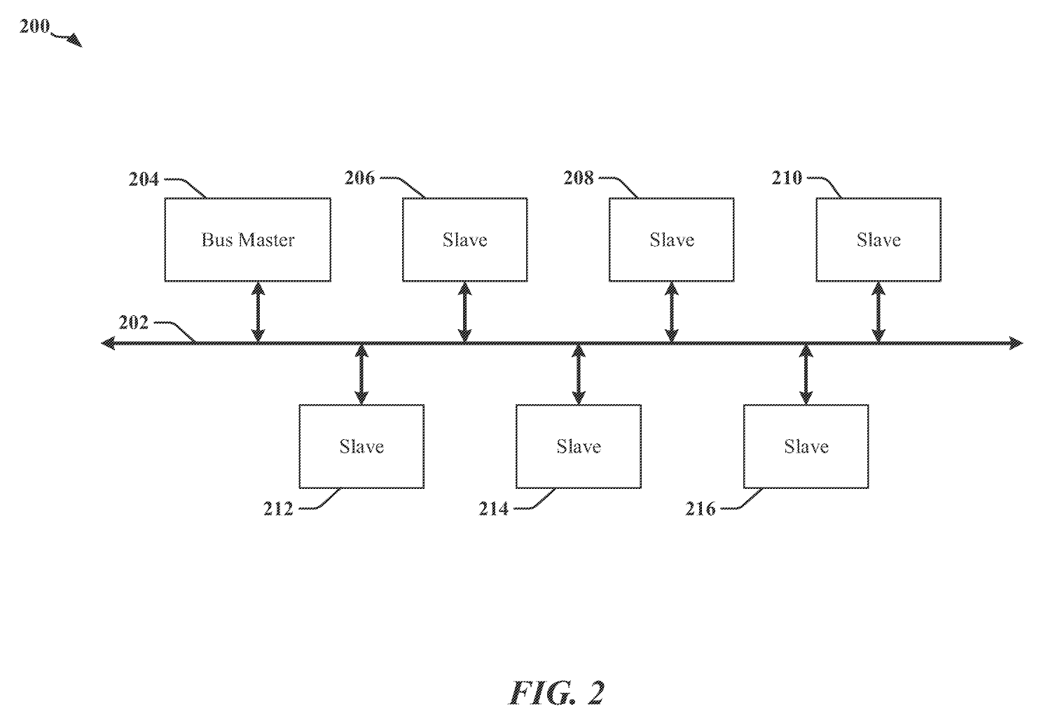

FIG. 2 illustrates a communication link 200 in which a configuration of devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

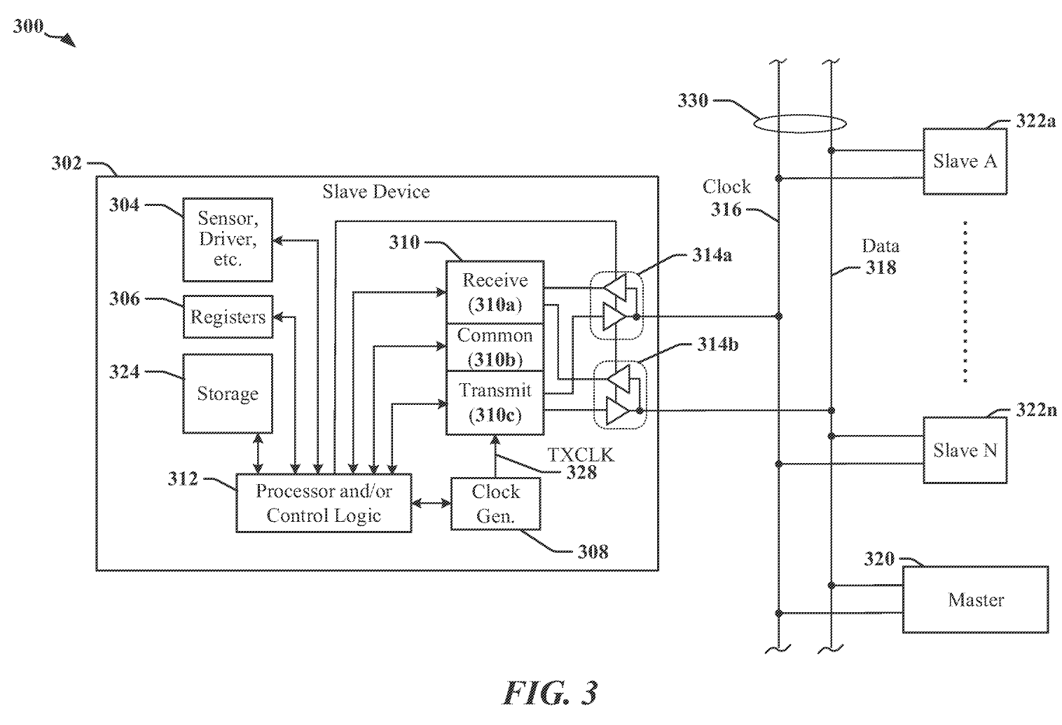

FIG. 3 illustrates certain aspects of an apparatus 300 that includes multiple devices 302, 320 and 322a-322n connected to a serial bus 330. The serial bus 330 may include a first wire 316 that carries a clock signal in certain modes of operation while a second wire 318 carries a data signal. In other modes of operation, data may be encoded in multi-bit symbols, where each bit of the symbol controls signaling state of one of the wires 316, 318. The devices 302, 320 and 322a-322n may include one or more semiconductor IC devices, such as an applications processor, SoC or ASIC. Each of the devices 302, 320 and 322a-322n may include, support or operate as a modem, a signal processing device, a display driver, a camera, a user interface, a sensor, a sensor controller, a media player, a transceiver, and/or other such components or devices. Communications between devices 302, 320 and 322a-322n over the serial bus 330 is controlled by a bus master 320. Certain types of bus can support multiple bus masters 320.

The apparatus 300 may include multiple devices 302, 320 and 322a-322n that communicate when the serial bus 330 is operated in accordance with I2C, I3C or other protocols. At least one device 302, 322a-322n may be configured to operate as a slave device on the serial bus 330. In one example, a slave device 302 may be adapted to provide a sensor control function 304. The sensor control function 304 may include circuits and modules that support an image sensor, and/or circuits and modules that control and communicate with one or more sensors that measure environmental conditions. The slave device 302 may include configuration registers 306 or other storage 324, control logic 312, a transceiver 310 and line drivers/receivers 314a and 314b. The control logic 312 may include a processing circuit such as a state machine, sequencer, signal processor or general-purpose processor. The transceiver 310 may include a receiver 310a, a transmitter 310c and common circuits 310b, including timing, logic and storage circuits and/or devices. In one example, the transmitter 310c encodes and transmits data based on timing provided by a clock generation circuit 308.

Two or more of the devices 302, 320 and/or 322a-322n may be adapted according to certain aspects and features disclosed herein to support a plurality of different communication protocols over a common bus, which may include an SMBus protocol, an SPI protocol, an I2C protocol, and/or an I3C protocol. In some examples, devices that communicate using one protocol (e.g., an I2C protocol) can coexist on the same serial bus with devices that communicate using a second protocol (e.g., an I3C protocol). In one example, the I3C protocols may support a mode of operation that provides a data rate between 6 megabits per second (Mbps) and 16 Mbps with one or more optional high-data-rate (HDR) modes of operation that provide higher performance The I2C protocols may conform to de facto I2C standards providing for data rates that may range between 100 kilobits per second (kbps) and 3.2 Mbps. I2C and I3C protocols may define electrical and timing aspects for signals transmitted on the 3-wire serial bus 330, in addition to data formats and aspects of bus control. In some aspects, the I2C and I3C protocols may define direct current (DC) characteristics affecting certain signal levels associated with the serial bus 330, and/or alternating current (AC) characteristics affecting certain timing aspects of signals transmitted on the serial bus 330.

High-Speed Data Transfers Over an I3C Serial Bus

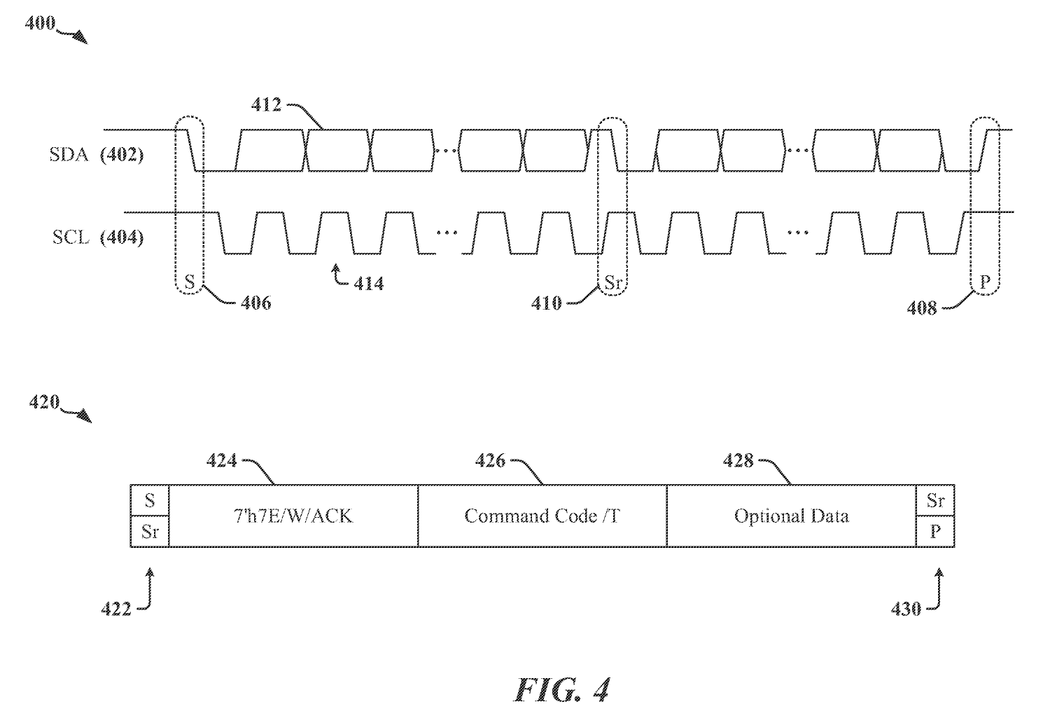

FIG. 4 includes a timing diagram 400 that illustrates signaling on a serial bus when the serial bus is operated in a single data rate (SDR) mode of operation defined by I3C specifications. Data transmitted on a first wire (the SDA wire 402) of the serial bus may be captured using a clock signal transmitted on a second wire (the SCL wire 404) of the serial bus. During data transmission, the signaling state 412 of the SDA wire 402 is expected to remain constant for the duration of the pulses 414 when the SCL wire 404 is at a high voltage level. Transitions on the SDA wire 402 when the SCL wire 404 is at the high voltage level indicate a START condition 406, a STOP condition 408 or a repeated START 410.

On an I3C serial bus, a START condition 406 is defined to permit the current bus master to signal that data is to be transmitted. The START condition 406 occurs when the SDA wire 402 transitions from high to low while the SCL wire 404 is high. The bus master may signal completion and/or termination of a transmission using a STOP condition 408. The STOP condition 408 is indicated when the SDA wire 402 transitions from low to high while the SCL wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the SDA wire 402 transitions from high to low while the SCL wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined command 424 indicating that a command code 426 is to follow. The command code 426 may, for example, cause the serial bus to transition to a desired mode of operation. In some instances, data 428 may be transmitted. The command code transmission 420 may be followed by a terminator 430 that may be a STOP condition 408 or a repeated START 410.

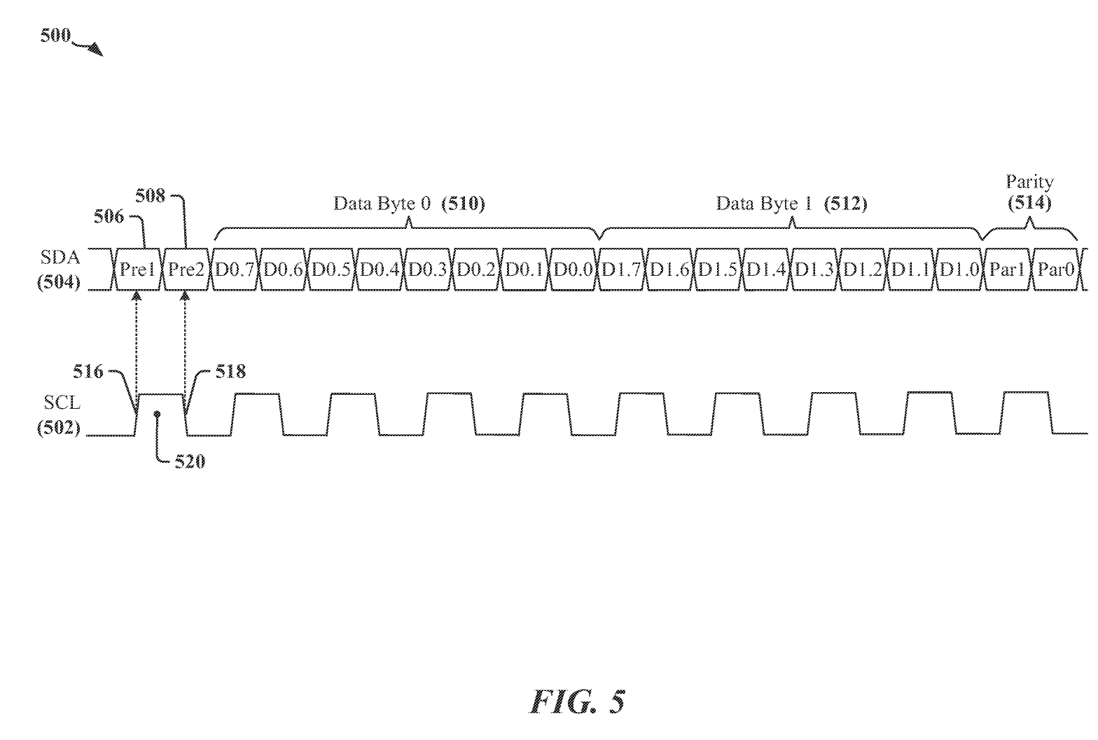

Certain serial bus interfaces support signaling schemes that provide higher data rates. In one example, I3C specifications define multiple high data rate (HDR), including a high data rate, double data rate (HDR-DDR) mode in which data is transferred at both the rising edge and the falling edge of the clock signal. FIG. 5 is a timing diagram 500 that illustrates an example of a transmission in an I3C HDR-DDR mode, in which data transmitted on the SDA wire 504 is synchronized to a clock signal transmitted on the SCL wire 502. The clock signal includes pulses 520 that are defined by a rising edge 516 and a falling edge 518. A master device transmits the clock signal on the SCL wire 502, regardless of the direction of flow of data over the serial bus. A transmitter outputs one bit of data at each edge 516, 518 of the clock signal. A receiver captures one bit of data based on the timing of each edge 516, 518 of the clock signal.

Certain other characteristics of an I3C HDR-DDR mode transmission are illustrated in the timing diagram 500 of FIG. 5. According to certain I3C specifications, data transferred in HDR-DDR mode is organized in words. A word generally includes 16 payload bits, organized as two 8-bit bytes 510, 512, preceded by two preamble bits 506, 508 and followed by two parity bits 514, for a total of 20 bits that are transferred on the edges of 10 clock pulses. The integrity of the transmission may be protected by the transmission of the parity bits 514.

In HDR-DDR mode, the physical SDA wire 504 is driven actively by the sender of the data, and the receiver has no ability to send a request in a signal on the SDA wire 504 to cease or suspend transmissions. A request to cease or suspend transmission may be desirable to implement a flow-control capability for the serial link. Absent the availability of flow-control, the receiver must absorb all transmitted data, irrespective of the ability of the receiver to process, store or forward the data. In some instances, flow-control techniques may be useful or desirable when memory space of the receiver has been exhausted, the transfer delivers data too quickly, or the receiver is busy or burdened handling other tasks, etc.

In some implementations of the I3C standards, the I3C HDR-DDR protocol may support flow-control for read procedures, where a slave device is transferring data to a bus master device. Flow-control for a read procedure enables the master device to terminate a read transaction. According to certain aspects disclosed herein, devices coupled to a serial bus may be adapted to provide flow-control for I3C HDR-DDR write procedures, where the master device or a peer slave device is transmitting data to the slave device. Flow-control procedures implemented for I3C HDR-DDR write procedures enables a slave device to signal a request to the master device to terminate a write transaction.

According to certain aspects disclosed herein, a slave device may request the master device to terminate a write transaction by manipulating one or more preamble bits 506, 508. In some instances, a master device may assume control of the serial bus and terminate the current transaction in response to the request to terminate the write transaction. In other instances, the sender can continue the data transfer. Termination or continuation of a transaction may depend on the type of transaction. A master device may initiate termination of a transaction by transmitting a HDR Restart or EXIT pattern.

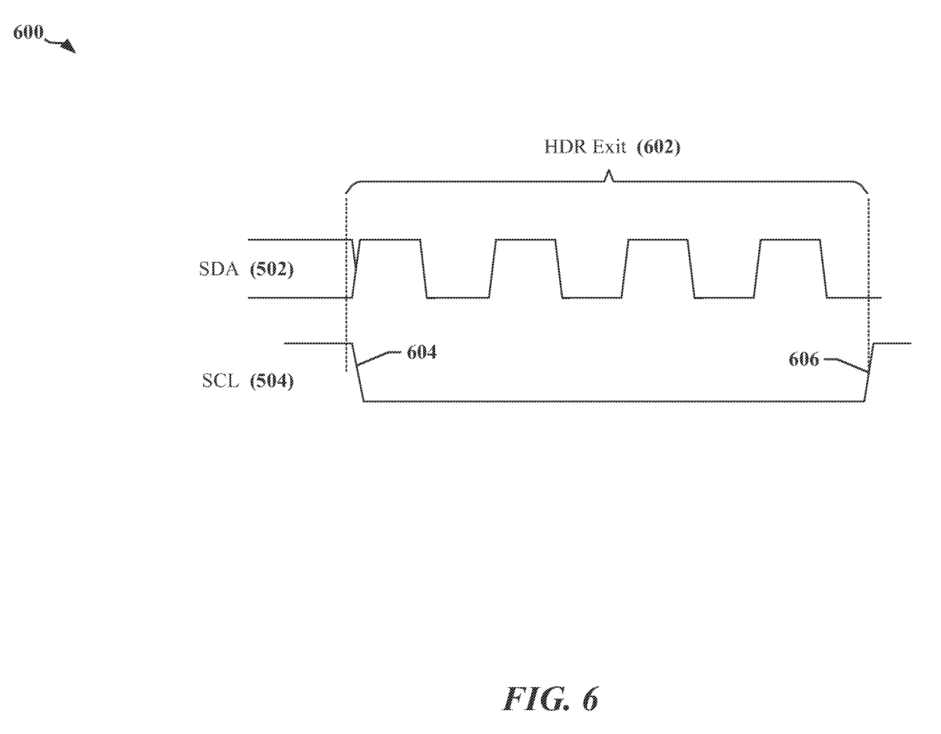

FIG. 6 illustrates an example of signaling 600 transmitted on the SDA wire 504 and SCL wire 502 to initiate certain mode changes. The signaling 600 is defined by I3C protocols for use in initiating restart, exit and/or break from I3C HDR modes of communication. The signaling 600 includes an HDR Exit 602 that may be used to cause an HDR break or exit. The HDR Exit 602 commences with a falling edge 604 on the SCL wire 502 and ends with a rising edge 606 on the SCL wire 502. While the SCL wire 502 is in low signaling state, four pulses are transmitted on the SDA wire 504. I2C devices ignore the SDA wire 504 when no pulses are provided on the SCL wire 502.

Flow Control for HDR-DDR Modes

Various examples discussed herein may be based on, or refer to a serial bus operated in accordance with the I3C HDR-DDR mode defined by the MIPI Alliance. The use of MIPI I3C HDR-DDR mode and other I3C modes are referenced as examples only, and the principles disclosed herein are applicable in other contexts.

In I3C HDR-DDR modes, the sender of the data actively drives the SDA wire 504, and no other lines are free or available to permit a receiver to signal flow-control requests to the sender. Consequently, the receiver is required to absorb all transmitted data, irrespective of whether the receiver can use the data, store the data or forward the data to its intended destination. Situations may occur where data is discarded when, for example, memory space in the receiver is exhausted, when the data transfer occurs too quickly for the processor or other circuits to handle incoming data, or when the receiver is busy performing other tasks, etc.

Certain aspects disclosed herein provide circuits and techniques by which a receiver can request the sender to terminate or suspend data transfer. The disclosed circuits and techniques may be employed to implement a flow control mechanism when all physical lines are being driven by the sender.

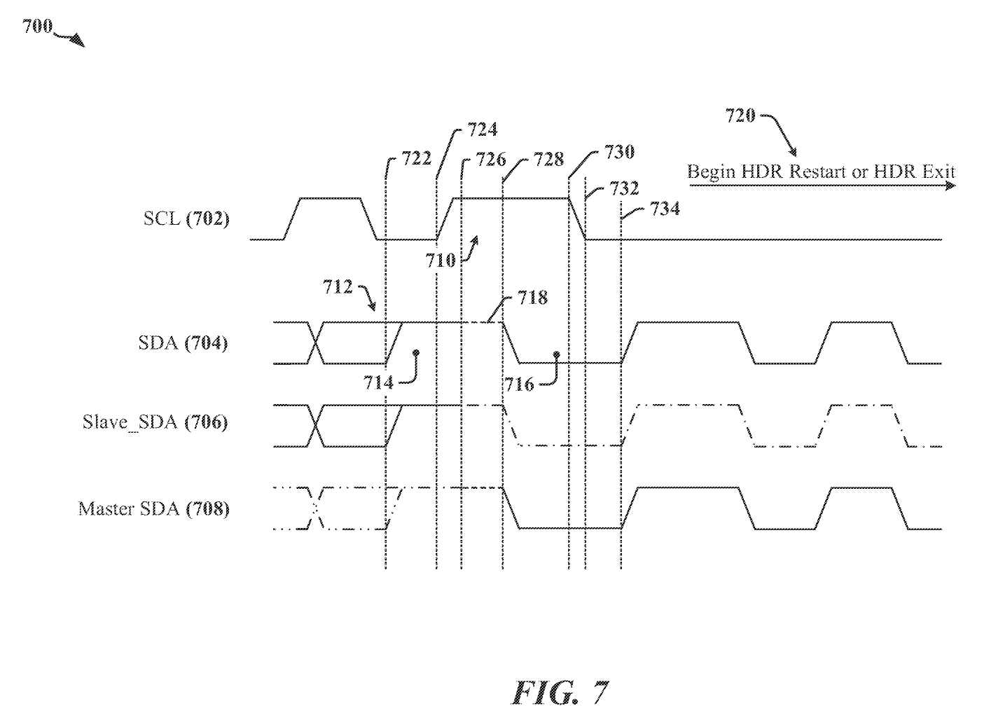

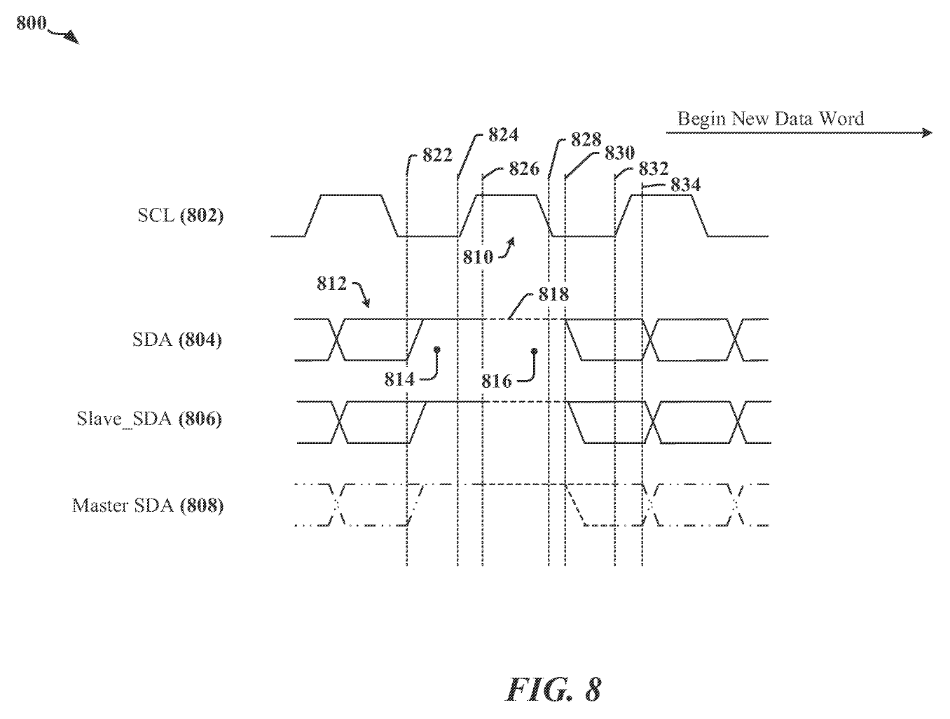

FIGS. 7 and 8 include timing diagrams 700, 800 that illustrate examples of flow-control asserted by a master device during I3C HDR-DDR transmission of data from a slave device to the master device. The timing diagrams 700, 800 depict signaling on the SCL wire 702 and the SDA wire 704. As illustrated, the SCL wire 702 is driven solely by the master device, while the SDA wire 704 may be driven by either the master device or the slave device. Line drivers in the master device and the slave devices that are coupled to the SDA wire 704 may provide a tristate mode such that a pull-up resistor or the like may be coupled to the SDA wire 704 when the line drivers are operated in tristate mode. In some examples, the pull-up resistor may be coupled to the SDA wire 704 through a switch. The timing diagram 700 depicts a slave_SDA signal 706 that is produced by a line driver in the slave device, and a master_SDA signal 708 that is produced by a line driver in the master device. The combination of the master_SDA signal 708 and the slave_SDA signal 706 may result in the signal transmitted on the SDA wire 704.

The timing diagram 700 illustrates a first example in which a master device receiving data from the slave device provides flow-control feedback to the slave device requesting that the slave device terminate or suspend transmissions. After the last parity bit 712 has been transmitted at a first point in time 722, the slave device drives the SDA wire 704 high during the next preamble bit 714, which is required to be high. At a second point in time 724, the master device begins driving the SCL wire 702 to provide a rising edge of a clock pulse 710. The master device may also enable an open-drain class pull-up circuit or structure coupled to the SDA wire 704. At a third point in time 726 (i.e. after a time t_{SCO}), the slave device ceases driving the SDA wire 704 low and disables its line driver coupled to the SDA wire 704, such that the output of the line driver enters a high impedance state.

At a fourth point in time 728, after a period of time longer than t_{SCO} of the slave device, the master device begins to drive the SDA wire 704 low. In one example, the period of time may be equivalent to a half cycle of the clock signal transmitted on the SCL wire 702. In another example, the period of time may be equivalent to a full-cycle of the clock signal transmitted on the SCL wire 702. The resultant pulse 710 on the SCL wire 702 is longer than the 50 ns required for coexistence with Legacy I2C devices. The resultant combined signaling on the SCL wire 702 and the SDA wire 704 corresponds to a repeated START condition. The stop condition may be followed by an EXIT pattern and a STOP.

At a fifth point in time 730, after another delay, the master device may begin driving the SCL wire 702 low, providing a falling edge of the second clock pulse 710. The slave device is monitoring the SDA wire 704 and, at a sixth point in time 732, the slave device may determine that the master device has requested termination or suspension of data transmission when the SDA wire 704 has been driven low. The slave device may maintain its line driver in the high impedance state. At a seventh point in time 734, after another delay similar to that described at the fourth point in time 728, the master device starts driving the SDA wire 704 high, preparing for a pattern signaling HDR Restart or HDR EXIT 720, which terminates the data transfer from the slave device to the master device.

The timing diagram 800 illustrates a second example in which a master device receiving data from the slave device refrains from providing flow-control feedback to the slave device, such that the slave device continues transmissions. After the last parity bit 812 has been transmitted at a first point in time 822, the master device drives the SDA wire 804 high during the next preamble bit 814, which is required to be high. At a second point in time 824, the master device begins driving the SCL wire 802 to provide a rising edge of a clock pulse 810. The master device may also enable an open-drain class pull-up circuit or structure coupled to the SDA wire 804. A third point in time 826 may correspond to a protocol-specified Clock to Data Turnaround Time (t_{SCO}). At the third point in time 826, the slave device ceases driving the SDA wire 804 low and disables its line driver coupled to the SDA wire 804, such that the output of the line driver enters a high impedance state.

The slave device is monitoring the SDA wire 804 and, at a fourth point in time 828, the slave device may determine that the master device has not requested termination or suspension of data transmission when the SDA wire 804 remains high. At a fifth point in time 830, after a delay, the slave device begins actively driving the SDA wire 804 to transmit the first bit of data payload of the next word. After a suitable delay, and at a sixth point in time 832, the master device may disable the pull-up circuit or structure coupled to the SDA wire 804 and may set its line driver in the high impedance state. The delay may be at least equal to slave device t_{SCO}. In one example, the delay may last until rising edge of the clock pulse 810. At a seventh point in time 734, after another delay corresponding to its t_{SCO}, the slave device starts driving the second bit of the data payload on the SDA wire 804.

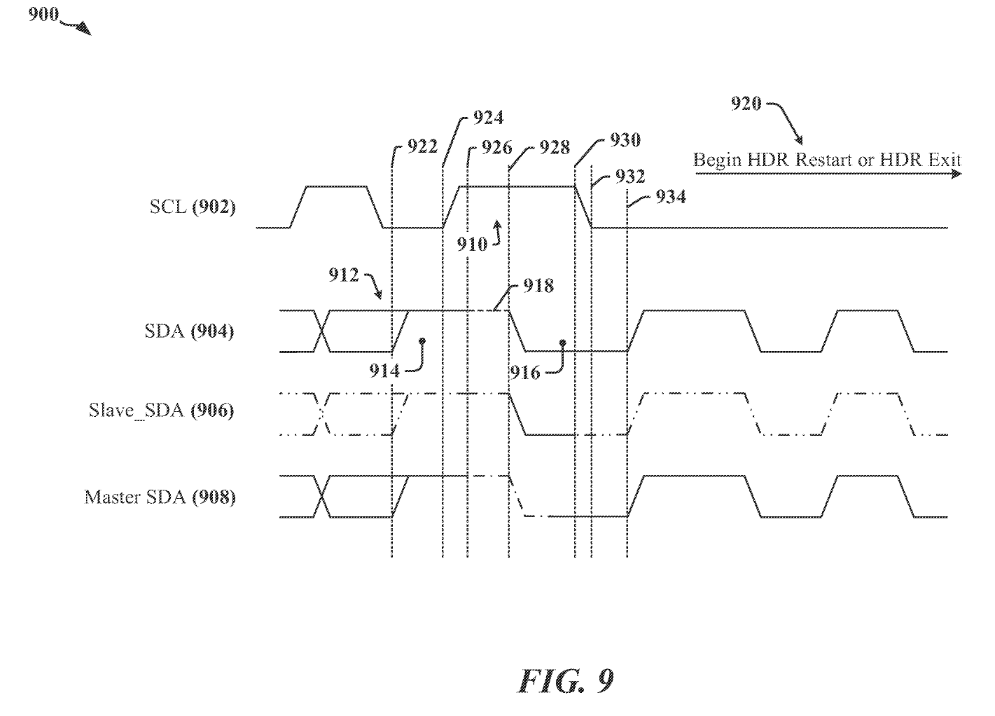

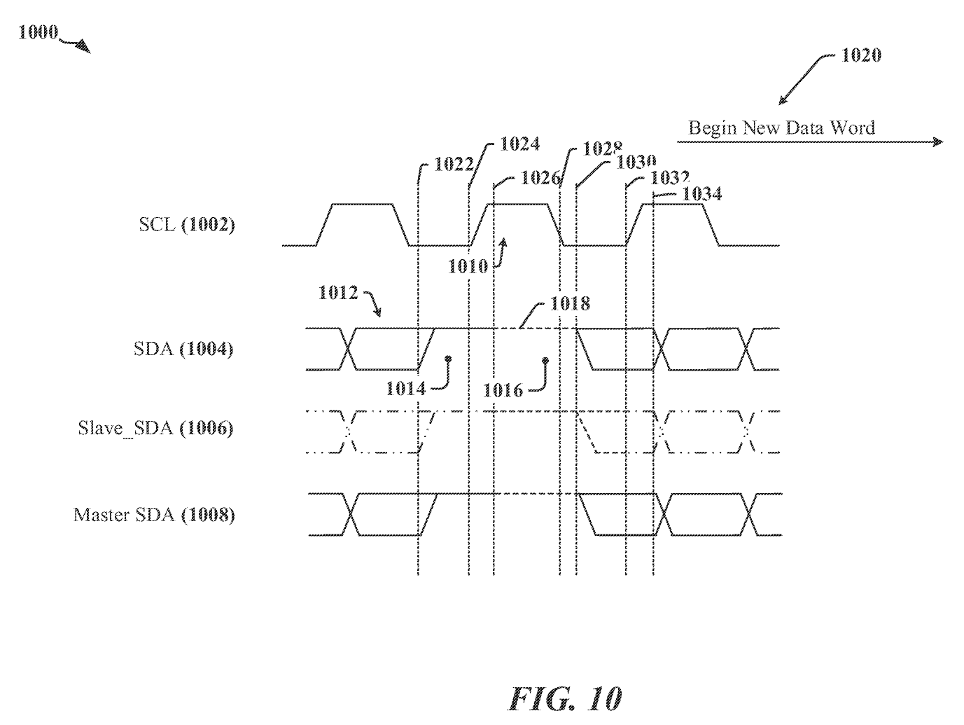

FIGS. 9 and 10 provide timing diagrams 900, 1000 that illustrate an example of flow-control asserted by a slave device during transmission of data from a master device to the slave device. The timing diagrams 900, 1000 depict signaling on the SCL wire 902 and the SDA wire 904. In the illustrated examples, the SCL wire 902 is driven by the master device, while the SDA wire 904 may be driven by either the master device or the slave device. Line drivers in the master device and the slave devices that are coupled to the SDA wire 904 may be operable in a tristate mode such that a pull-up resistor or the like may be coupled to the SDA wire 904 when the line drivers are operated in tristate mode. In some examples, the pull-up resistor may be coupled to the SDA wire 904 through a switch. The timing diagram 900 depicts a slave_SDA signal 906 that is produced by a line driver in the slave device, and a master_SDA signal 908 that is produced by a line driver in the master device. The combination of the master_SDA signal 908 and the slave_SDA signal 906 may result in the signal transmitted on the SDA wire 904.

The timing diagram 900 illustrates a first example in which a slave device receiving data from the master device provides flow-control feedback to the master device requesting that the master device terminate or suspend transmissions. After the last parity bit 912 has been transmitted at a first point in time 922, the master device drives the SDA wire 904 high during the next preamble bit 914, which is required to be high. At a second point in time 924, the master device begins driving the SCL wire 902 to provide a rising edge of a clock pulse 910. The master device may also enable an open-drain class pull-up circuit or structure coupled to the SDA wire 904. At a third point in time 926 (i.e. after a time t_{SCO}), the slave device enables its line driver coupled to the SDA wire 904 and begins actively driving the SDA wire 904 low.

At a fourth point in time 928, the master device begins to drive the SDA wire 904 low for the falling edge of the second clock pulse 910. The master device knows that the slave device has driven the SDA wire 904 low and selects the value of the second preamble bit 912 accordingly. The master device and the slave device may be driving the SDA wire 904 concurrently.

At a fifth point in time 930, after another delay (t_{SCO}), the slave device may cause a line driver coupled to the SDA wire 904 to enter a high impedance state. At a sixth point in time 932 the master device may begin driving the SDA wire 904 high after a suitable delay. The delay may correspond to a half cycle of the clock signal on the SCL wire 902. At a seventh point in time 934, after a delay such as that provided at the sixth point in time 932, the SDA wire 904 is actively driven high by the master device, and the SCL wire 902 is actively driven low by the master device. Both line drivers in the slave device are in a high-impedance state. The master device may initiate a pattern signaling HDR Restart or HDR EXIT 920, which terminates the data transfer from the slave device to the master device.

The timing diagram 1000 illustrates a second example in which a slave device receiving data from the master device refrains from providing flow-control feedback to the master device, such that the master device continues transmissions. After the last parity bit 1012 has been transmitted at a first point in time 1022, the master device drives the SDA wire 1004 high during the next preamble bit 1014, which is required to be high. At a second point in time 1024, the master device begins driving the SCL wire 1002 to provide a rising edge of a clock pulse 1010. The master device may also enable an open-drain class pull-up circuit or structure coupled to the SDA wire 1004. At a third point in time 826, the master device starts the falling edge of clock pulse 1010. The master device may have detected that the SDA wire 1004 has remained in a high state and that the preamble bit is 1016 is high. The master device may determine that the slave device has not requested termination or suspension of data transmission. The master device may start actively driving the SDA wire 1004 high.

At fourth point in time 1028, after a suitable delay, the master device may start actively driving the SDA wire 1004 high or low as required for the first data payload bit. At a fifth point in time 1030, the master device starts a rising edge in the clock signal on the SCL wire 1002. The line drivers in the slave device are both configured for high-impedance mode. Data transfer from the master device to the slave device continues with data sampling occurs at sixth and seventh points in time 1032, 1034.

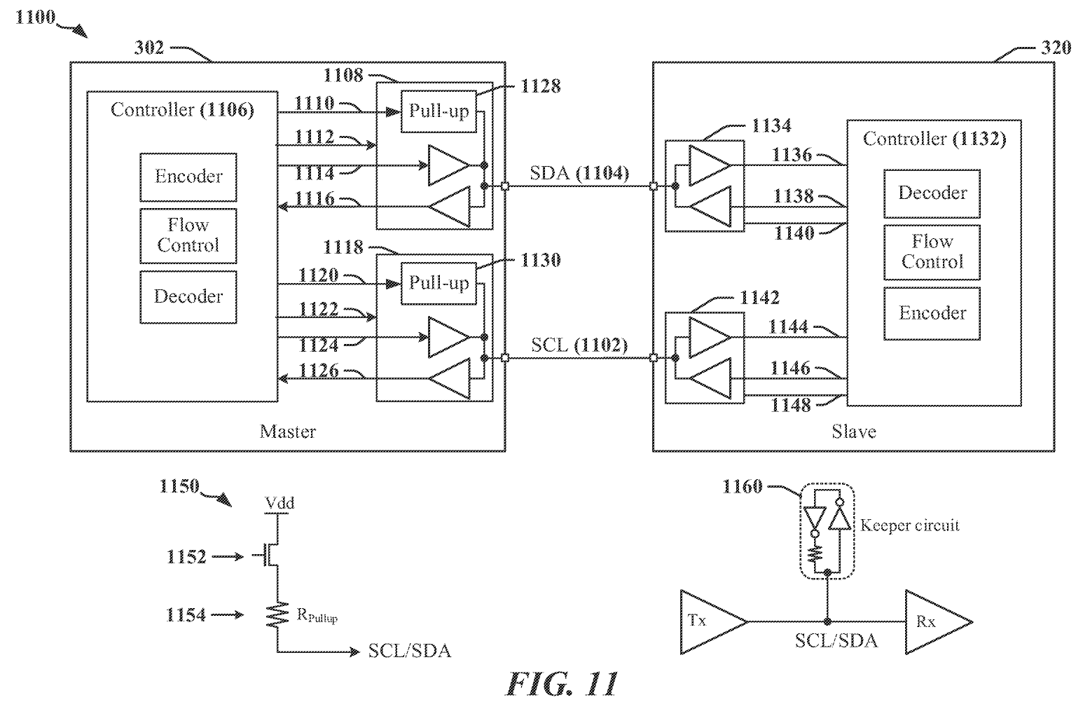

FIG. 11 illustrates an example of an I3C interface 1100 that has been adapted in accordance with certain aspects disclosed herein. A master device 320 is coupled to the SCL wire 1102 and SDA wire 1104 of a serial interface. A slave device 302 is also coupled to the SCL wire 1102 and SDA wire 1104 of the serial interface. The master device 320 and the slave device 302 include respective interface controllers 1106, 1132 that may include encoders, decoders and flow control circuits and modules.

The master device 320 and the slave device 302 include transceivers 1108, 1118, 1134 and 1142 that may be used to transmit and receive signals over a respective wire 1102, 1104. The transceivers 1108, 1118 in the master device 320 include pull-up circuits or structures 1128, 1130 which may be used to emulate an open-drain pull-up coupled to the SCL wire 1102 and SDA wire 1104. The interface controller 1106 in the master device 320 may provide a control signal 1110, 1120 that enables or disables the operation of corresponding pull-up circuits or structures 1128, 1130.

The interface controller 1106 in the master device 320 may provide impedance control signals 1112, 1122 that can be used to place line drivers in the transceivers 1108, 1118 into a high-impedance mode of operation. The interface controller 1106 in the master device 320 may provide a master SDA signal 1114 (see also the signals on the master_SDA wires 708, 808, 908 and 1008), and receive an SDA_signal 1116 from the SDA wire 1104 (see also the SDA wires 704, 904). The interface controller 1106 in the master device 320 may provide a master SCL signal 1124 and receive an SCL_signal 1126 from the SCL wire 1102 (see also the signals on the SCL wires 702, 902).

The interface controller 1132 in the slave device 302 may provide impedance control signals 1138, 1148 that can be used to place line drivers in the transceivers 1134, 1142 into a high-impedance mode of operation. The interface controller 1132 in the slave device 302 may provide a slave SDA signal 1136 (see also the master_SDA wires 708, 808, 908 and 1008), and receive an SDA_signal 1134 from the SDA wire 1104 (see also the signals on the SDA wires 704, 904). The interface controller 1132 in the slave device 302 may provide a slave SCL signal 1146 and receive an SCL_signal 1144 from the SCL wire 1102 (see also the signals on the SCL wires 702, 902).

The pull-up circuits or structures 1128, 1130 may be implemented using a variety of circuits. In one example, a pull-up circuit includes a pull-up resistor 1154 that may be coupled to a source of high voltage (V_{dd}) through a switch 1152, which may include a suitably configured transistor. In some instances, the pull-up resistor 1154 may be coupled directly to V_{dd} and the switch couples the pull-up structure to the SCL wire 1102 or SDA wire 1104. In another example, the pull-up circuits or structures 1128, 1130 may be implemented using a keeper circuit 1160. The keeper circuit 1160 may be configured as a positive feedback circuit that drives the SCL wire 1102 or SDA wire 1104 through a high impedance output, and receives feedback from the SCL wire 1102 or SDA wire 1104 through a low impedance input. The keeper circuit 1160 may be configured to maintain the last asserted voltage on the SCL wire 1102 or SDA wire 1104. The keeper circuit 1160 can be easily overcome by line drivers in the master device 320 or slave device 302.

Examples of Processing Circuits and Methods

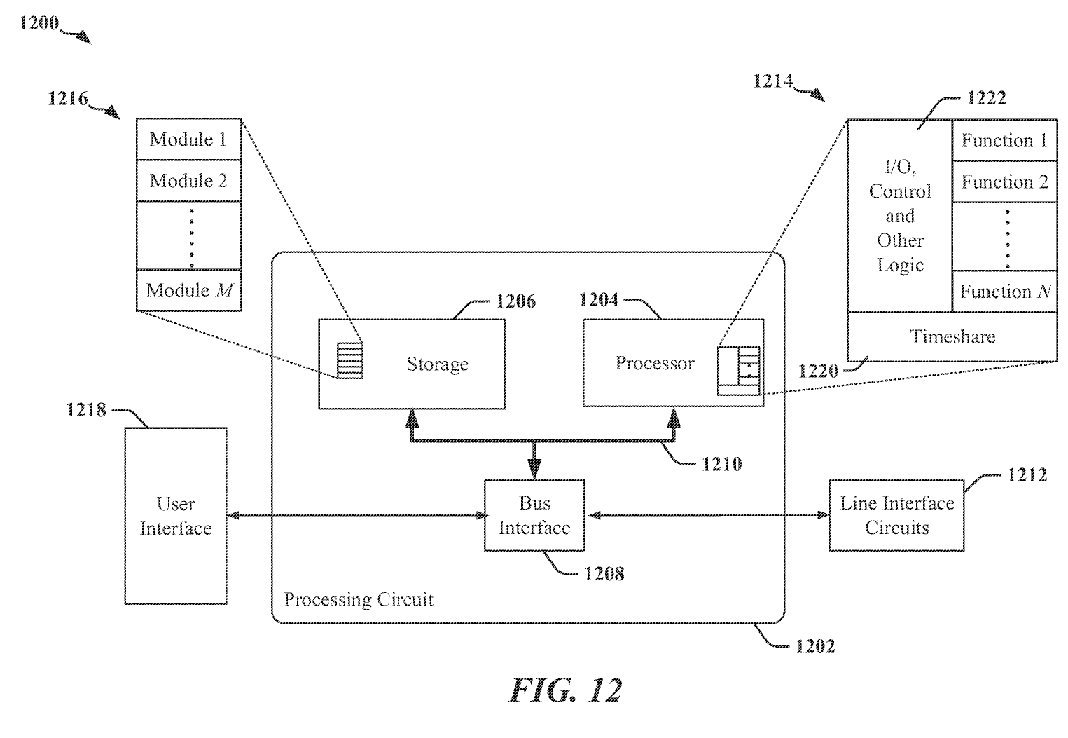

FIG. 12 is a diagram illustrating an example of a hardware implementation for an apparatus 1200 employing a processing circuit 1202 that may be configured to perform one or more functions disclosed herein. In accordance with various aspects of the disclosure, an element, or any portion of an element, or any combination of elements as disclosed herein may be implemented using the processing circuit 1202. The processing circuit 1202 may include one or more processors 1204 that are controlled by some combination of hardware and software modules. Examples of processors 1204 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1204 may include specialized processors that perform specific functions, and that may be configured, augmented or controlled by one of the software modules 1216. The one or more processors 1204 may be configured through a combination of software modules 1216 loaded during initialization, and further configured by loading or unloading one or more software modules 1216 during operation. In various examples, the processing circuit 1202 may be implemented using a state machine, sequencer, signal processor and/or general-purpose processor, or a combination of such devices and circuits.

In the illustrated example, the processing circuit 1202 may be implemented with a bus architecture, represented generally by the bus 1210. The bus 1210 may include any number of interconnecting buses and bridges depending on the specific application of the processing circuit 1202 and the overall design constraints. The bus 1210 links together various circuits including the one or more processors 1204, and storage 1206. Storage 1206 may include memory devices and mass storage devices, and may be referred to herein as computer-readable media and/or processor-readable media. The bus 1210 may also link various other circuits such as timing sources, timers, peripherals, voltage regulators, and power management circuits. A bus interface 1208 may provide an interface between the bus 1210 and one or more transceivers 1212. A transceiver 1212 may be provided for each networking technology supported by the processing circuit. In some instances, multiple networking technologies may share some or all of the circuitry or processing modules found in a transceiver 1212. Each transceiver 1212 provides a means for communicating with various other apparatus over a transmission medium. Depending upon the nature of the apparatus 1200, a user interface 1218 (e.g., keypad, display, speaker, microphone, joystick) may also be provided, and may be communicatively coupled to the bus 1210 directly or through the bus interface 1208.

A processor 1204 may be responsible for managing the bus 1210 and for general processing that may include the execution of software stored in a computer-readable medium that may include the storage 1206. In this respect, the processing circuit 1202, including the processor 1204, may be used to implement any of the methods, functions and techniques disclosed herein. The storage 1206 may be used for storing data that is manipulated by the processor 1204 when executing software, and the software may be configured to implement any one of the methods disclosed herein.

One or more processors 1204 in the processing circuit 1202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1206 or in an external computer-readable medium. The external computer-readable medium and/or storage 1206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1206 may also include, by way of example, a carrier wave, a transmission line, and any other suitable medium for transmitting software and/or instructions that may be accessed and read by a computer. Computer-readable medium and/or the storage 1206 may reside in the processing circuit 1202, in the processor 1204, external to the processing circuit 1202, or be distributed across multiple entities including the processing circuit 1202. The computer-readable medium and/or storage 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1206 may maintain software maintained and/or organized in loadable code segments, modules, applications, programs, etc., which may be referred to herein as software modules 1216. Each of the software modules 1216 may include instructions and data that, when installed or loaded on the processing circuit 1202 and executed by the one or more processors 1204, contribute to a run-time image 1214 that controls the operation of the one or more processors 1204. When executed, certain instructions may cause the processing circuit 1202 to perform functions in accordance with certain methods, algorithms and processes described herein.

Some of the software modules 1216 may be loaded during initialization of the processing circuit 1202, and these software modules 1216 may configure the processing circuit 1202 to enable performance of the various functions disclosed herein. For example, some software modules 1216 may configure internal devices and/or logic circuits 1222 of the processor 1204, and may manage access to external devices such as the transceiver 1212, the bus interface 1208, the user interface 1218, timers, mathematical coprocessors, and so on. The software modules 1216 may include a control program and/or an operating system that interacts with interrupt handlers and device drivers, and that controls access to various resources provided by the processing circuit 1202. The resources may include memory, processing time, access to the transceiver 1212, the user interface 1218, and so on.

One or more processors 1204 of the processing circuit 1202 may be multifunctional, whereby some of the software modules 1216 are loaded and configured to perform different functions or different instances of the same function. The one or more processors 1204 may additionally be adapted to manage background tasks initiated in response to inputs from the user interface 1218, the transceiver 1212, and device drivers, for example. To support the performance of multiple functions, the one or more processors 1204 may be configured to provide a multitasking environment, whereby each of a plurality of functions is implemented as a set of tasks serviced by the one or more processors 1204 as needed or desired. In one example, the multitasking environment may be implemented using a timesharing program 1220 that passes control of a processor 1204 between different tasks, whereby each task returns control of the one or more processors 1204 to the timesharing program 1220 upon completion of any outstanding operations and/or in response to an input such as an interrupt. When a task has control of the one or more processors 1204, the processing circuit is effectively specialized for the purposes addressed by the function associated with the controlling task. The timesharing program 1220 may include an operating system, a main loop that transfers control on a round-robin basis, a function that allocates control of the one or more processors 1204 in accordance with a prioritization of the functions, and/or an interrupt driven main loop that responds to external events by providing control of the one or more processors 1204 to a handling function.

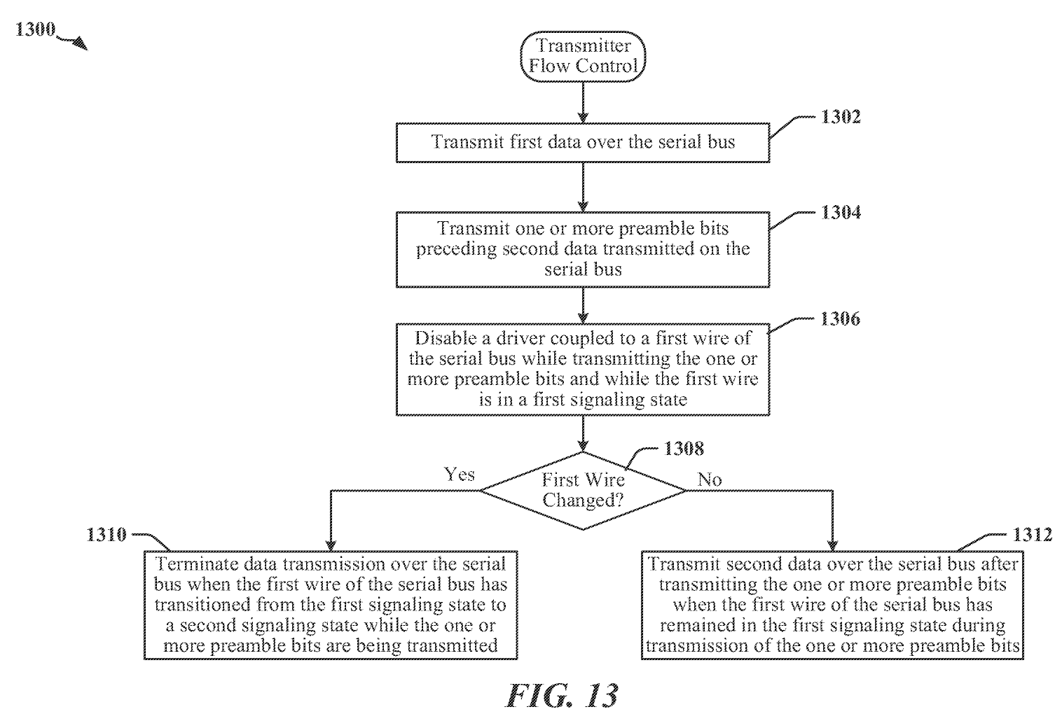

FIG. 13 is a flowchart 1300 illustrating a flow-control process that may be performed at a sending device coupled to a serial bus.

At block 1302, the sending device may transmit first data over the serial bus. In one I3C example, the serial bus may be configured for an HDR-DDR mode of operation.

At block 1304, the sending device may transmit one or more preamble bits preceding second data transmitted on the serial bus.

At block 1306, the sending device may disable a driver coupled to a first wire of the serial bus while transmitting the one or more preamble bits and while the first wire is in a first signaling state;

At block 1308, the sending device may determine whether the first signaling state has changed while the one or more preamble bits were being transmitted.

At block 1310, the sending device may terminate data transmission over the serial bus when the first wire of the serial bus has transitioned from the first signaling state to a second signaling state while the one or more preamble bits are being transmitted.

At block 1312, the sending device may transmit second data over the serial bus after transmitting the one or more preamble bits when the first wire of the serial bus has remained in the first signaling state during transmission of the one or more preamble bits.

In one example, the sending device is a master device, and disabling the driver coupled to the first wire of the serial bus may include causing a line driver coupled to the serial bus to enter a high impedance state, and enabling a pull-up circuit coupled to the first wire of the serial bus.

In one example, transmitting the first data over the serial includes transmitting a bit of data on each edge of a pulse of a clock signal transmitted on a second wire of the serial bus.

In various examples, the serial bus is operated in accordance with an I3C protocol. Terminating the data transmission may include transmitting an HDR exit pattern or HDR restart pattern on the serial bus.

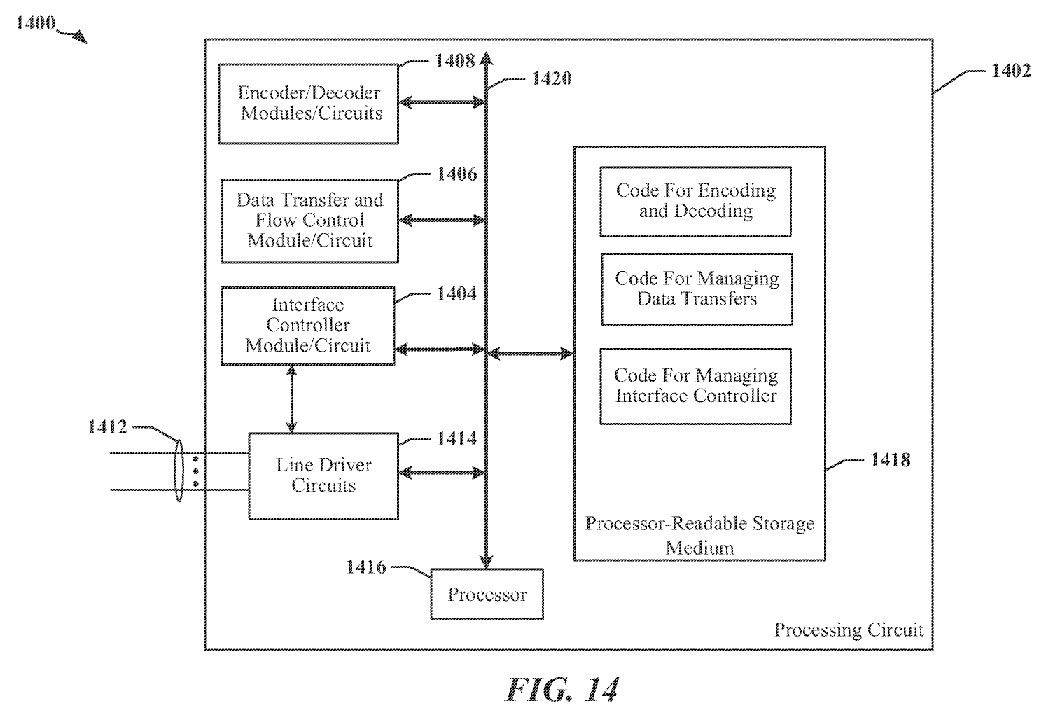

FIG. 14 is a diagram illustrating a simplified example of a hardware implementation for an apparatus 1400 employing a processing circuit 1402. The processing circuit typically has a controller or processor 1416 that may include one or more microprocessors, microcontrollers, digital signal processors, sequencers and/or state machines. The processing circuit 1402 may be implemented with a bus architecture, represented generally by the bus 1420. The bus 1420 may include any number of interconnecting buses and bridges depending on the specific application of the processing circuit 1402 and the overall design constraints. The bus 1420 links together various circuits including one or more processors and/or hardware modules, represented by the controller or processor 1416, the modules or circuits 1404, 1406 and 1408, and the computer-readable storage medium 1418. The apparatus may be coupled to a multi-wire communication link using a physical layer circuit 1414. The physical layer circuit 1414 may operate the multi-wire communication link 1412 to support communications in accordance with I3C protocols. The bus 1420 may also link various other circuits such as timing sources, peripherals, voltage regulators, and power management circuits, which are well known in the art, and therefore, will not be described any further.

The processor 1416 is responsible for general processing, including the execution of software, code and/or instructions stored on the computer-readable storage medium 1418. The computer-readable storage medium may include a non-transitory storage medium. The software, when executed by the processor 1416, causes the processing circuit 1402 to perform the various functions described supra for any particular apparatus. The computer-readable storage medium may be used for storing data that is manipulated by the processor 1416 when executing software. The processing circuit 1402 further includes at least one of the modules 1404, 1406 and 1408. The modules 1404, 1406 and 1408 may be software modules running in the processor 1416, resident/stored in the computer-readable storage medium 1418, one or more hardware modules coupled to the processor 1416, or some combination thereof. The modules 1404, 1406 and 1408 may include microcontroller instructions, state machine configuration parameters, or some combination thereof.

In one configuration, the apparatus 1400 includes an interface controller 1404, and line driver circuits 1414 including a first line driver coupled to a first wire of a multi-wire serial bus and a second line driver coupled to a second wire of the multi-wire serial bus 1412. The apparatus may include modules and/or circuits 1404, 1408, 1414 configured to transmit first data over the serial bus while the serial bus 1412 is configured for a DDR mode of operation. The apparatus may include modules and/or circuits 1404, 1406, 1414 configured to transmit one or more preamble bits preceding second data transmitted on the serial bus 1412. The apparatus may include modules and/or circuits 1404, 1414 configured to disable a driver coupled to a first wire of the serial bus 1412 while transmitting the one or more preamble bits and while the first wire is in a first signaling state. The apparatus may include modules and/or circuits 1406 configured to terminate data transmission over the serial bus when the first wire of the serial bus 1412 has transitioned from the first signaling state to a second signaling state while the one or more preamble bits are being transmitted. The apparatus may include modules and/or circuits 1404, 1408, 1414 configured to transmit second data over the serial bus 1412 after transmitting the one or more preamble bits when the first wire of the serial bus 1412 has remained in the first signaling state during transmission of the one or more preamble bits.

In some examples, the apparatus is a master device and includes a pull-up circuit coupled to the first wire of the serial bus. The driver coupled to the first wire of the serial bus may be disabled by causing the first line driver to enter a high impedance state, and enabling the pull-up circuit.

In one example, the modules and/or circuits 1404 include an interface controller that is configured to transmit a bit of data on each edge of a pulse of a clock signal transmitted on a second wire of the serial bus 1412 in the DDR mode of operation.

In one example, the serial bus 1412 is operated in accordance with an I3C protocol. The interface controller may be configured to transmit an HDR exit pattern or an HDR restart pattern on the serial bus 1412 when terminating data transmissions.

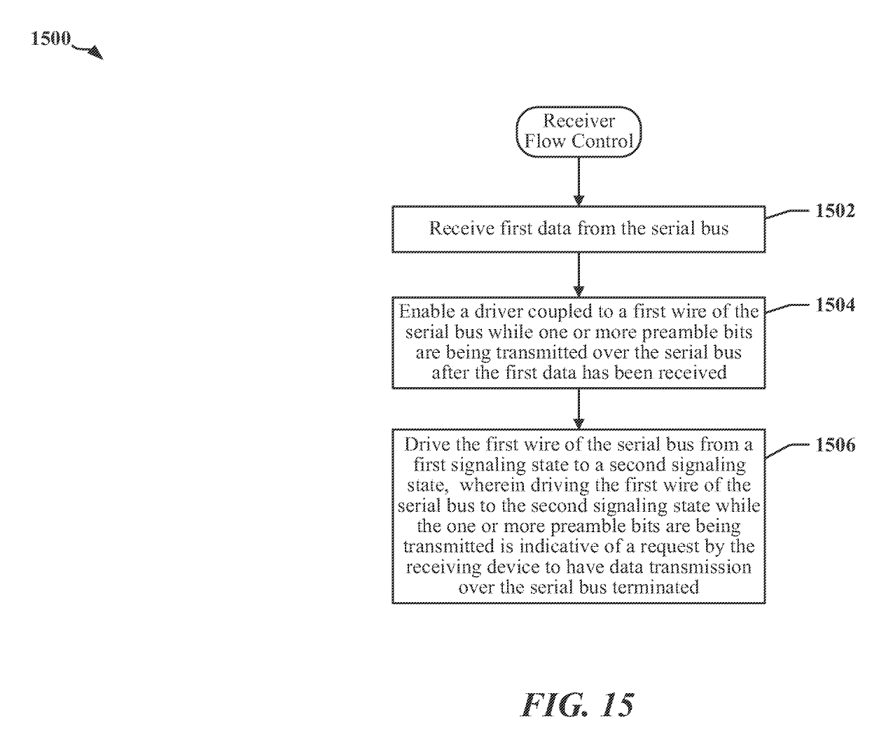

FIG. 15 is a flowchart 1500 illustrating a flow-control process that may be performed at a receiving device coupled to a serial bus.

At block 1502, the receiving device may receive first data from the serial bus. In one example, the serial bus may be configured for an HDR-DDR mode of operation.

At block 1504, the receiving device may enable a driver coupled to a first wire of the serial bus while one or more preamble bits are being transmitted over the serial bus after the first data has been received.

At block 1504, the receiving device may drive the first wire of the serial bus from a first signaling state to a second signaling state. Driving the first wire of the serial bus to the second signaling state while the one or more preamble bits are being transmitted may be indicative of a request by the receiving device to have data transmission over the serial bus terminated.

In one example, the receiving device is a slave device, and enabling the driver coupled to the first wire of the serial bus may include causing a line driver coupled to the serial bus to exit a high impedance state.

In one example, receiving the first data over the serial bus may include using each edge of a pulse in a signal transmitted on a second wire of the serial bus to receive a bit of data.

In some examples, the serial bus is operated in accordance with an I3C protocol. The receiving device may receive an HDR exit pattern or an HDR restart pattern from the serial bus, wherein the HDR exit pattern and the HDR restart pattern are associated with a termination of a current data transmission over the serial bus.

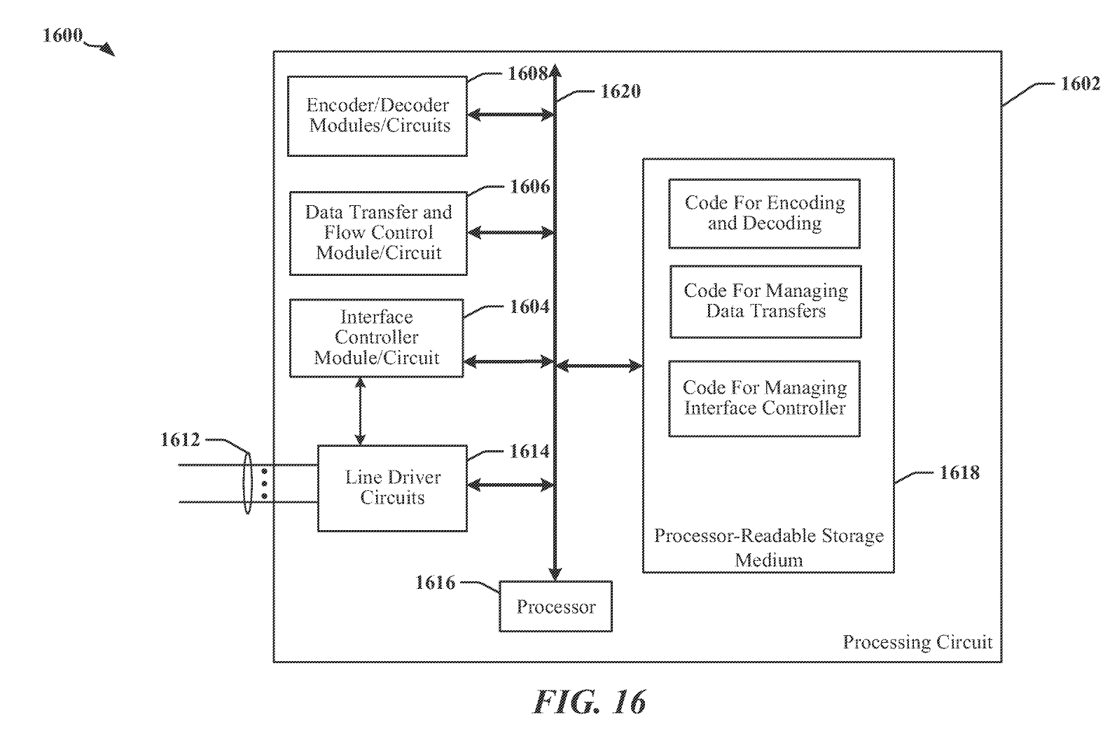

FIG. 16 is a diagram illustrating a simplified example of a hardware implementation for an apparatus 1600 employing a processing circuit 1602. The processing circuit typically has a controller or processor 1616 that may include one or more microprocessors, microcontrollers, digital signal processors, sequencers and/or state machines. The processing circuit 1602 may be implemented with a bus architecture, represented generally by the bus 1620. The bus 1620 may include any number of interconnecting buses and bridges depending on the specific application of the processing circuit 1602 and the overall design constraints. The bus 1620 links together various circuits including one or more processors and/or hardware modules, represented by the controller or processor 1616, the modules or circuits 1604, 1606 and 1608, and the computer-readable storage medium 1618. The apparatus may be coupled to a multi-wire communication link using a physical layer circuit 1614. The physical layer circuit 1614 may operate the multi-wire communication link configured as a serial bus 1612 to support communications in accordance with an I2C and/or I3C protocol. The bus 1620 may also link various other circuits such as timing sources, peripherals, voltage regulators, and power management circuits, which are well known in the art, and therefore, will not be described any further.

The processor 1616 is responsible for general processing, including the execution of software, code and/or instructions stored on the computer-readable storage medium 1618. The computer-readable storage medium may include a non-transitory storage medium. The software, when executed by the processor 1616, causes the processing circuit 1602 to perform the various functions described supra for any particular apparatus. The computer-readable storage medium may be used for storing data that is manipulated by the processor 1616 when executing software. The processing circuit 1602 further includes at least one of the modules 1604, 1606 and 1608. The modules 1604, 1606 and 1608 may be software modules running in the processor 1616, resident/stored in the computer-readable storage medium 1618, one or more hardware modules coupled to the processor 1616, or some combination thereof. The modules 1604, 1606 and 1608 may include microcontroller instructions, state machine configuration parameters, or some combination thereof.

In one configuration, the apparatus 1600 includes a first line driver coupled to a first wire of a multi-wire serial bus, a second line driver coupled to a second wire of the multi-wire serial bus. The apparatus 1600 may include modules and/or circuits 1604, 1606, 1614 configured to receive first data from the serial bus 1612 while the serial bus 1612 is configured for a DDR mode of operation. The apparatus 1600 may include modules and/or circuits 1604, 1614 configured to enable a driver coupled to a first wire of the serial bus 1612 while one or more preamble bits are being transmitted over the serial bus 1612 after the first data has been received, drive the first wire of the serial bus from a first signaling state to a second signaling state. The first wire of the serial bus 1612 being driven to the second signaling state while the one or more preamble bits are being transmitted may be indicative of a request by the receiving device to have data transmission over the serial bus terminated.

In one example, the apparatus is a master device and the modules or circuits 1604 may include an interface controller that may cause a line driver coupled to the serial bus 1612 to exit a high impedance state.

In one example, the interface controller receives the first data over the serial bus 1612 using each edge of a pulse in a signal transmitted on a second wire of the serial bus 1612 to receive a bit of data.

In various examples, the serial bus 1612 is operated in accordance with an I3C protocol. A HDR exit pattern or HDR restart pattern received from the serial bus 1612 may be associated with a termination of a current data transmission over the serial bus 1612.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method performed at a transmitting device coupled to a serial bus, comprising:
transmitting first data over the serial bus;
transmitting one or more preamble bits preceding second data transmitted on the serial bus;
disabling a driver coupled to a first wire of the serial bus while transmitting the one or more preamble bits and while the first wire is in a first signaling state;
terminating data transmission over the serial bus when the first wire of the serial bus has transitioned from the first signaling state to a second signaling state while the one or more preamble bits are being transmitted; and
transmitting second data over the serial bus after transmitting the one or more preamble bits when the first wire of the serial bus has remained in the first signaling state during transmission of the one or more preamble bits.

2. The method of claim 1, wherein the transmitting device comprises a master device, and wherein disabling the driver coupled to the first wire of the serial bus comprises:
causing a line driver coupled to the serial bus to enter a high impedance state; and
enabling a pull-up circuit coupled to the first wire of the serial bus.

3. The method of claim 2, wherein the pull-up circuit comprises a keeper circuit.

4. The method of claim 2, wherein the pull-up circuit comprises a switch operable to couple a resistor to the first wire of the serial bus.

5. The method of claim 1, wherein transmitting the first data over the serial comprises:
transmitting a bit of data on each edge of a pulse of a clock signal transmitted on a second wire of the serial bus.

6. The method of claim 1, wherein the serial bus is operated in accordance with a high data rate (HDR) double data rate mode of operation of an I3C protocol.

7. The method of claim 6, wherein terminating data transmission over the serial bus comprises:
transmitting an HDR exit pattern on the serial bus.

8. The method of claim 6, wherein terminating data transmission over the serial bus comprises:
transmitting an HDR restart pattern on the serial bus.

9. An apparatus, comprising:
a first line driver coupled to a first wire of a multi-wire serial bus;
a second line driver coupled to a second wire of the multi-wire serial bus; and
an interface controller configured to:
transmit first data over the serial bus;
transmit one or more preamble bits preceding second data transmitted on the serial bus;
disable a driver coupled to a first wire of the serial bus while transmitting the one or more preamble bits and while the first wire is in a first signaling state;
terminate data transmission over the serial bus when the first wire of the serial bus has transitioned from the first signaling state to a second signaling state while the one or more preamble bits are being transmitted; and
transmit second data over the serial bus after transmitting the one or more preamble bits when the first wire of the serial bus has remained in the first signaling state during transmission of the one or more preamble bits.

10. The apparatus of claim 9, wherein the apparatus comprises a master device, and further comprising:
a pull-up circuit coupled to the first wire of the serial bus when the driver coupled to a first wire of the serial bus is disabled.

11. The apparatus of claim 10, wherein the driver coupled to the first wire of the serial bus is disabled by:
causing the first line driver to enter a high impedance state; and
enabling the pull-up circuit.

12. The apparatus of claim 10, wherein the pull-up circuit comprises a keeper circuit.

13. The apparatus of claim 10, wherein the pull-up circuit comprises a switch operable to couple a resistor to the first wire of the serial bus.

14. The apparatus of claim 9, wherein the interface controller is configured to:
transmit a bit of data on each edge of a pulse of a clock signal transmitted on a second wire of the serial bus.

15. The apparatus of claim 9, wherein the serial bus is operated in accordance with an I3C protocol and wherein the serial bus is configured for a high data rate (HDR) double data rate mode of operation.

16. The apparatus of claim 15, wherein the interface controller is configured to:
transmit an HDR exit pattern on the serial bus when terminating data transmission over the serial bus.

17. The apparatus of claim 15, wherein the interface controller is configured to:
transmit an HDR restart pattern on the serial bus when terminating data transmission over the serial bus.

18. A method performed at a receiving device coupled to a serial bus, comprising:
receiving first data from the serial bus;
enabling a driver coupled to a first wire of the serial bus while one or more preamble bits are being transmitted over the serial bus after the first data has been received; and
driving the first wire of the serial bus from a first signaling state to a second signaling state,
wherein driving the first wire of the serial bus to the second signaling state while the one or more preamble bits are being transmitted is indicative of a request by the receiving device to have data transmission over the serial bus terminated.

19. The method of claim 18, wherein the receiving device comprises a slave device, and wherein enabling the driver coupled to the first wire of the serial bus comprises:
causing a line driver coupled to the serial bus to exit a high impedance state.

20. The method of claim 18, wherein receiving the first data over the serial bus comprises:
using each edge of a pulse in a signal transmitted on a second wire of the serial bus to receive a bit of data.

21. The method of claim 18, wherein the serial bus is configured for a high data rate (HDR) double data rate mode of operation in accordance with an I3C protocol.

22. The method of claim 21, further comprising:
receiving an HDR exit pattern from the serial bus, wherein the HDR exit pattern is associated with a termination of a current data transmission over the serial bus.

23. The method of claim 21, further comprising:
receiving an HDR restart pattern from the serial bus, wherein the HDR restart pattern is associated with a termination of a current data transmission over the serial bus.

24. An apparatus, comprising:
a first line driver coupled to a first wire of a multi-wire serial bus;
a second line driver coupled to a second wire of the multi-wire serial bus; and
an interface controller configured to:
receive first data from the serial bus while the serial bus;
enable a driver coupled to a first wire of the serial bus while one or more preamble bits are being transmitted over the serial bus after the first data has been received; and
drive the first wire of the serial bus from a first signaling state to a second signaling state,
wherein the first wire of the serial bus being driven to the second signaling state while the one or more preamble bits are being transmitted is indicative of a request by the apparatus to have data transmission over the serial bus terminated.

25. The apparatus of claim 24, wherein the apparatus comprises a master device, and wherein the interface controller enables the driver coupled to the first wire of the serial bus by:
causing a line driver coupled to the serial bus to exit a high impedance state.

26. The apparatus of claim 24, wherein the interface controller receives the first data over the serial bus using each edge of a pulse in a signal transmitted on a second wire of the serial bus to receive a bit of data.

27. The apparatus of claim 24, wherein the serial bus is configured for a high data rate (HDR) double data rate mode of operation in accordance with an I3C protocol.

28. The apparatus of claim 27, wherein the interface controller is configured to:
receive an HDR exit pattern from the serial bus, wherein the HDR exit pattern is associated with a termination of a current data transmission over the serial bus.

29. The apparatus of claim 27, wherein the interface controller is configured to:
receive an HDR restart pattern from the serial bus, wherein the HDR restart pattern is associated with a termination of a current data transmission over the serial bus.
